(19) United States
(12) Patent Application Publication
(10) Pub. No.: US 2015/0190907 A1
(43) Pub. Date: Jul. 9, 2015

(54) Power Tool to Spring Torsioner Converter

(71) Applicant: GARY L HAMMAN, GARLAND, TX (US)

(72) Inventor: GARY L HAMMAN, GARLAND, TX (US)

(21) Appl. No.: 14/593,244

(22) Filed: Jan. 9, 2015

Related U.S. Application Data
(63) Continuation-in-part of application No. 14/025,827, filed on Sep. 13, 2013.

(51) Int. Cl. B25B 21/00; E05D 13/00

(52) U.S. Cl. CPC B25B 21/002; E05D 13/1253

(57) ABSTRACT

A device that converts an existing power tool to apply a rotational force to a spring of a rollup or overhead door counterbalancing mechanism. The device has a rotatable driven gear mounted in a casting that carries a power transmitting structure. The casting and the driven gear have slots with an open end for accommodating the shaft of the counterbalancing mechanism. A removable novel coupling structure inserts into the driven gear and connects the driven gear to the winding cone of a spring so that rotation of the driven gear will apply rotational force to the spring. The casting with the driven gear is connected to the body of an existing power tool in place of the original tool head. A motor in the existing power tool body is connected to the power transmitting structure in the casting to rotate the driven gear.

### CROSS-REFERENCE TO RELATED APPLICATIONS

This Application is a Continuation-in-Part of U.S. Non-provisional application Ser. No. 14/025,827 Titled “A Power Tool to Spring Torsioner Converter” and Filed Sep. 13, 2013.

### BACKGROUND OF THE INVENTION

1. Field of the Invention

The invention relates to implements for applying tension, e.g., torque, to a spring.

2. Description of Related Art

Power tools, using air or electric motors, are commonly used to rapidly turn nuts, bolts, and screws. However, these tools as currently marketed are not designed to apply twisting (torsion) forces to the springs of a counterbalancing mechanism of a door, such as an overhead garage door system. Most of these door mechanisms utilize long coil springs that are placed under a rotational or torsion force to apply a lifting force to the door. The springs are concentrically positioned about a rotatable shaft mounted on fixed supports. On the shaft are drums accommodating cables, and the cables are attached to the bottom panel of the door so that when the drums are rotated, a lifting force will be applied to the door. The lifting force is transmitted from the torsion springs to the drums by the shaft. The springs are anchored on one end, with the free end connected to a winding cone on the shaft, and the winding cone is then rotated to “load” the springs (place the springs under torsion force). When the torsion force is “loaded”, the winding cone is then connected to the shaft by a mechanical means, and the system is ready.

Long steel rods may be inserted into open bores in the winding cone to rotate the winding cone and “load” the spring. The amount of force that can be applied to the spring is limited by the strength of the person using the rods, since rotating the winding cone in this manner is a manual operation. The procedure requires a considerable amount of time and can be dangerous as the spring becomes loaded with considerable force.

There have been other designs patented to introduce temporary mechanical power to “load” these door springs. These require some setup work over the shaft or at the winding cone of each spring before they can begin to “load” the spring. The others referenced are for permanently installed mechanisms, increasing both the installation and subsequent repair costs. The present invention is safer to use than a manual procedure, and eliminates the setup times of the other inventions. The present invention also utilizes a simpler design with fewer moving parts to wear out, and eliminates the increased costs associated with the permanent mechanisms

### SUMMARY OF THE INVENTION

The present invention is related to an apparatus for applying rotational force to an object, as a fastener, a fastener assembly, or the winding cone connected to a spring of a door counterbalancing mechanism. More particularly, the apparatus converts a power tool to apply rotational force to a torsion coil spring of a door counterbalancing mechanism. The device has a casing with a slot to accommodate the shaft of the counterbalancing mechanism. The casing is connected to a power tool that can be held during rotation of the driven member such as driven gear 5 shown in the preferred embodiment herein. The power tool can also be engaged by a fixed support to prevent rotation of the casing during winding of the spring of the door counterbalancing mechanism. The rotatable driven member is housed in the casing.

The driven member has a slot to accommodate the shaft. A power transmitting means housed in the casing which includes reduction gearing also known in the art as a speed reducer, or worm gearbox (not shown) of any conventional configuration as would be appreciated by those having skill in the art and which can be possess any reduction ratio and which is often paired with a motor to increase torque and reduce output rotation of a tool is operable to continuously drive the driven member. A motor, such as an electric motor, is used to apply power to the power transmitting means. The driven member is connected to the winding cone with a novel cast coupling structure. One form of the novel cast coupling structure has an attached hook aligned to engage an open bore in the winding cone. An alternate form of the cast coupler has the hook incorporated in the casting. Other forms of engagement can be incorporated by modifying the coupler.

An object of the invention is to provide a power tool, usable with no set up required, to apply torsion forces to the spring of a door counterbalancing mechanism which is simple, safe and convenient to use and requires only one person.

A further object of the invention is to provide a power tool for applying torsion forces to the spring of a door counterbalancing mechanism that is operable, with a minimum of time and effort, to apply the torsion forces to the spring sufficient to counterbalance the door.

Another object of the invention is to provide a power tool that includes a motor that is compact in construction, relatively lightweight and efficient in use to apply torsion forces to the spring of a door counterbalancing mechanism.

Yet another object of the invention is to provide a reliable power tool with a driven gear having a slot to accommodate an object, as a shaft, so that the driven gear can be concentrically located with the shaft whereby on rotation of the driven gear rotational forces can be applied to an object mounted on the shaft. These and other objects and advantages of the invention are embodied in the following description of the preferred embodiments of the invention.

### BRIEF DESCRIPTION OF THE FIGURES

FIG. 1 in a prior art view, shows an elevation view of a sectional overhead door in the closed position;

FIG. 2 in a prior art view, shows a fragmentary elevation view of the spring area of the counterbalancing mechanism;

FIG. 3 shows a right elevation view of the body of the invention, without the coupler of sheet 3;

FIG. 4 shows a plan view of the top of the coupler;

FIG. 5 shows an elevation view of the coupler;

FIG. 6 shows a plan view of the bottom of the coupler.

### DESCRIPTION OF PREFERRED EMBODIMENTS

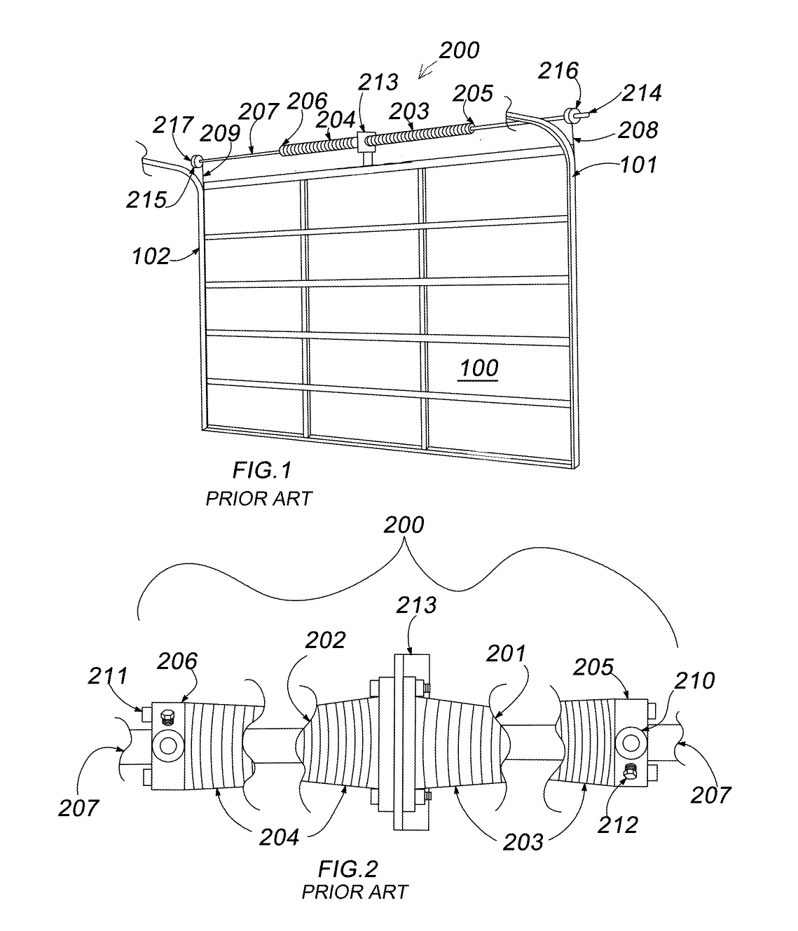

Referring to the drawings, FIG. 1 shows a conventional overhead door 100 in the closed position mounted against a structural wall. Overhead doors are usually made of metal, plastic or wood panels and have considerable weight. FIG. 2 on Sheet 1 shows a counterbalance mechanism 200 which is used to facilitate the safe and easy opening and closing of door 100.

Counterbalance mechanism 200 is located above the top of door 100 and has a generally transverse shaft 207. Transverse shaft 207 can be either hollow tube or solid bar, but the choice is determined by the weight to be lifted, and the outside diameter is the same for both. Opposite end portions of shaft 207 are supported in rotatable bearings 214 and 215. The center portion of shaft 207 is supported in a rotatable bearing 213. A plurality of fasteners (not shown) connect the supports 214, 215 and 213 to the structural wall adjacent to the top of door 100. In some installations, the shaft 207 may be supported in bearings on the remote ends of the tracks 101 and 102 near the door opening motor.

Adjacent to bearing 214 is drum 216 which is mechanically connected to shaft 207 by a set screw (similar to 212), and carries cable 208 to an attachment with a suitable fastener (not shown) to the bottom of door 100. Adjacent to bearing 215 is drum 217 which is mechanically connected to shaft 207 by a set screw (similar to 212), and carries cable 209 to an attachment with a suitable fastener (not shown) to the bottom of door 100.

Shaft 207 is subjected to rotational or turning forces by a pair of coil or helical springs 203 and 204. The static end of spring 203 is connected by anchor cone 201 to support bearing 213, and the opposite end is connected to winding cone 205. Cone 205 is mechanically connected to shaft 207 by a set screw 212. Set screw 212 can be released so that cone 205 can be rotated relative to shaft 207 to twist spring 203. The static end of spring 204 is connected by anchor cone 202 to support bearing 213, and the opposite end is connected to winding cone 206. Cone 206 is mechanically connected to shaft 207 by a set screw 212. Set screw 212 can be released so that cone 206 can be rotated relative to shaft 207 to twist spring 204. In some installations, a single heavy duty (larger wire gauge) spring is used to apply the counterbalancing rotational force to shaft 207, using similar mounting and connection scenarios as described above.

When door 100 moves from the open to the closed position, springs 203 and 204 are energized by the twisting action of shaft 207. The shaft 207 rotates as door 100 moves to its closed position, inducing sufficient inertial energy (torque) into springs 203 and 204 to counterbalance the majority of the weight of door 100. Springs 203 and 204 then have sufficient inertial energy (torque) so that door 100 can be opened with little effort. When door 100 is in the open position, springs 203 and 204 must retain a small amount of inertial energy (torque) to keep cables 208 and 209 taut, preventing the accidental closing of door 100. During door installation, winding cones 205 and 206 must be rotated and then connected to shaft 207 when door 100 is in the closed position, in order to set the initial amount of torque in springs 203 and 204 required for proper operation of door 100.

Prior to the present invention, the winding cones 205 and 206 were provided with a plurality of radial open bores 210 (see reference 4817927 cited) for the purpose of receiving long removable rods (not shown). These long rods were used to selectively hold and rotate the cones ¼ turn per rod insertion, thereby applying torque to the springs. When sufficient torque is applied to the springs, the winding cones 205 and 206 are connected to shaft 207. The rods used to rotate the winding cones 205 and 206 are then released and removed from the cones so that the torque of springs 203 and 204 is transmitted via the winding cones 205 and 206 to shaft 207. The power apparatus of the invention indicated on Sheets 2 & 3 is used to place the springs 203 and 204 under tension by turning the winding cones 205 and 206. Once the winding cones 205 and 206 are turned to the required torque, they are connected to shaft 207.

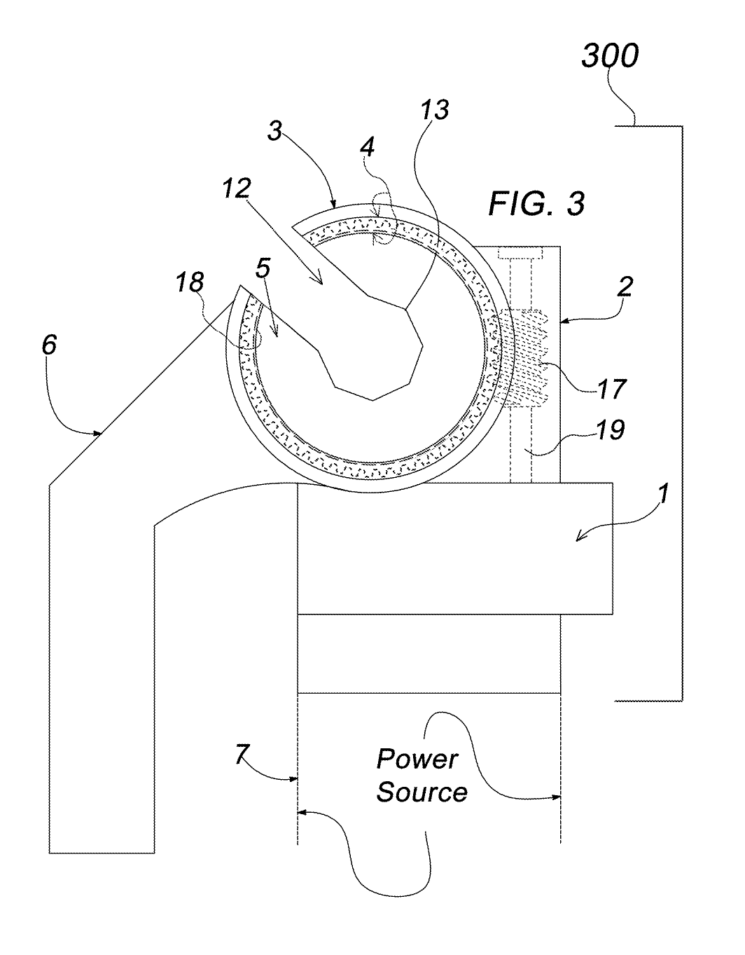

Referring to FIG. 3 on Sheet 2, the converter 300 consists of a cast metal housing with four distinct sections; the reduction gear section 1, the worm gear section 2, the driven gear section 3 and the handle 6. The reversible motor of power source 7 is connected by electrical cable to a standard electrical outlet. An on-off trigger switch and a reversing switch are used to control the power to the motor. The converter 300 attaches to an existing power tool body 7 (motor included but not shown). Power is transmitted from the motor, to the rotatable driven gear 5 mounted in section 3 of the housing. The driven gear 5 rests against a bearing shoulder of the same size as snap ring 4, and is secured in section 3 of the housing by snap ring 4. Driven gear 5 has a concentric semi-octagonal hole 13 to accommodate the novel coupler 400 on Sheet 3, and a radial slot 12 of a size required to accommodate shaft 207. The opening in the cast housing 300 is larger than slot 12 to allow for motor-spin and driven gear 5 movement after electrical power cut-off.

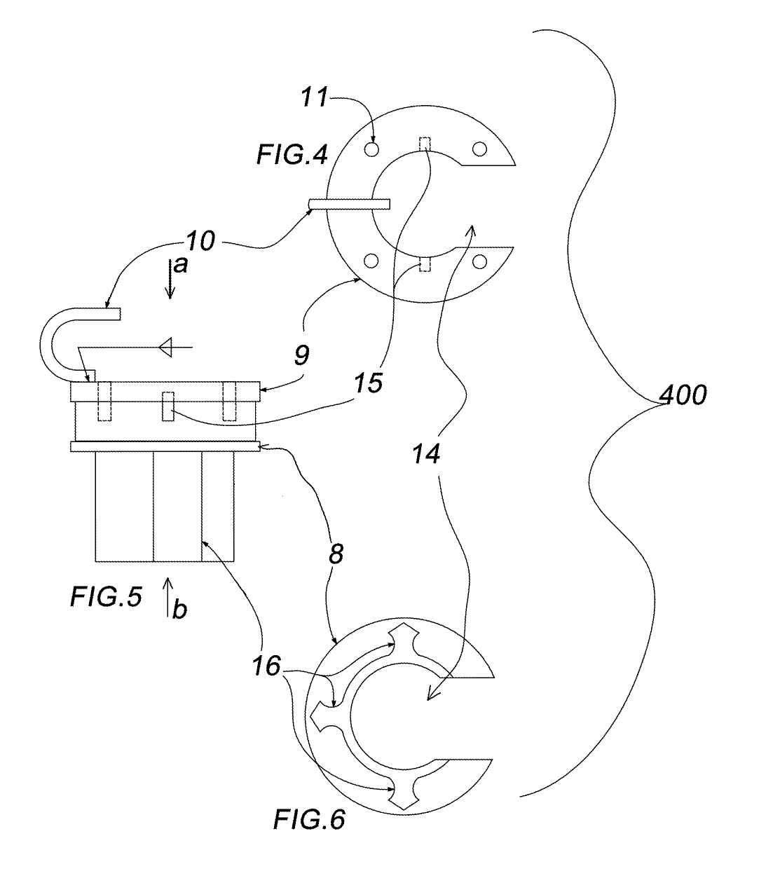

Referring to FIGS. 4-6 on Sheet 3, these show three views of novel coupler 400 for connecting to and rotating the winding cones 205 and 206. The cap 9 of novel coupler 400 is chrome steel with four holes 11 provided for screws (not shown) to attach cap 9 to body 8. A stainless hook 10 is welded to cap 9 and engages an open bore 210 on winding cone 205 or 206, winding either spring 203 or 204 to the required torque. Novel coupler 400 is inserted into hole 13 in driven gear 5 from the side toward the spring to be wound. An alternative method of winding springs 203 or 204 is to omit cap 9 and engage tabs 211 on winding cones 205 or 206 into slots 15 in body 8.

The body 8 of the novel coupler 400 is made of cast metal, and has three ridges 16 which are uniquely shaped, so that when slot 14 is aligned with slot 12 in the driven gear, they will fit into corresponding points of the semi-octagonal hole 13 of driven gear 5. This positions novel coupler 400 concentrically with driven gear 5, and with winding cones 205 or 206 and shaft 207, perfectly aligning all parts for winding springs 203 or 204 to the required amount of torque.

This converter 300 can also be used as a portable pipe threader to cut threads onto pipe ends by replacing coupler 400 with the appropriate size pipe die and cutting blades.

While there have been shown and described preferred embodiments of the invention, it is understood that changes in materials, size of the components, power transmission structures, coupling structures and other components can be made by those skilled in the art without departing from the invention.

I claim:

1. A device for applying rotational force to an object comprising:
a cast casing (300) which partially encloses a driven member and has an opening for accommodating a shaft;
a rotatable driven member housed in the casing, said driven member having a slot with an open end for accommodating a shaft and a semi-octagonal hole in the center to accommodate a coupling structure;
a power transmission housed in the casing for rotating the driven member, said power transmission connected to a motor whereby on operation of the motor the power transmission rotates the driven member; and,
a means connecting the driven member to the object whereby the object is rotated with the driven member, said means connecting the driven member to the object comprising a novel cast semi-octagonal structure having a slot (13) with an open end to accommodate a shaft, the semi-octagonal shape of the structure wherein the slot in the structure coincides with the slot in the driven member, and,
a coupler (400) mounted on the driven member that is engageable with the object whereby rotation of the structure by the driven member will rotate the object.

2. The device of claim 1 including a handle integral with or connected to the casing pointing back towards the motor to assist in positioning the device over the shaft and engaging an open bore.

3. The device of claim 1 wherein the driven member is an external-toothed gear said power transmission engaged directly so that the driven member is continuously rotated during operation of the motor.

4. The device of claim 3 wherein the power transmitting means includes a worm gear and shaft connected to the motor through reduction gearing.

5. The device of claim 1 wherein the casing comprises a body having a semi-circular chamber for the driven member, a bearing shoulder and snap ring to hold the driven member in place, said power transmitting means being located in said casing.

6. The device of claim 1 wherein the power transmission has at least one shaft adapted to be connected to the drive motor.

7. The device of claim 1 wherein the coupler comprises an integral hook aligned to project into an open bore or hole in the object.

8. The device of claim 1 wherein the coupler comprises an attached hook aligned to project into an open bore or hole in the object.

9. The device of claim 1 wherein the coupler comprises slots aligned to accept the integral tabs on the object.

10. The device of claim 1 wherein: the coupler comprises cut slots aligned to accept integral tabs on the object.
